(19) United States
(12) Patent Application Publication
(10) Pub. No.: US 2002/0142721 A1
(43) Pub. Date: Oct. 3, 2002

(54) Method and device for selecting a wireless communication path

(75) Inventors: Slim Souissi, San Diego, CA (US); Thomas C. Hill, Crystal Lake, IL (US)

Correspondence Address: MOTOROLA INC, 600 NORTH US HIGHWAY 45, LIBERTYVILLE, IL, 60048-5343, US

(73) Assignee: MOTOROLA, INC.

(21) Appl. No.: 09/821,545

(22) Filed: Mar. 29, 2001

(51) Int. Cl. H04B 5/00

(52) U.S. Cl. 455/41; 455/414

(57) ABSTRACT

Disclosed is a method of and device for selecting a path for communications between a source device and a target device in an ad-hoc communications system. Operations performed include; determining a first layer of neighbor devices, each neighbor device within the first layer capable of communicating with the source device; successively determining additional layers of neighbor devices, each neighbor device within a particular layer capable of communicating with one or more neighbor device within a preceding layer, until the target device is identified as one of the neighbor devices; and selecting the path including intervening neighbor devices capable of communicating with each other to form the path for communications from the source device to the target device.

### FIELD OF THE INVENTION

The present invention concerns an ad-hoc wireless communications systems and more particularly selecting a path for communications between source and target devices in such a system.

### BACKGROUND OF THE INVENTION

Communications networks and techniques for establishing a path between two devices such as would be found in the public switched telephone network are known to exist. Various ad-hoc communications systems, such as Bluetooth and IEEE 802.11b have been proposed and are being developed. These systems generally allow a device to form a connection with various other devices over a short range and thus over a limited geographic area. It is expected that as the systems proliferate and the number of devices using the systems dramatically increases these geographic areas may become even more limited.

These ad-hoc systems have been designed such that no allowance for roaming or handoff or connection from one area to another has been explicitly provided. Yet many expect that a user within one geographic area in these systems may well wish to communicate with a user in another such area. No such capability has been provided to date in the systems as specified by their respective specifications or standards. What is needed is a way to provide and select a communication path between disparate units in an ad-hoc communications system.

### BRIEF DESCRIPTION OF THE DRAWINGS

The accompanying figures, where like reference numerals refer to identical or functionally-similar elements throughout the separate views and which are incorporated in and form part of the specification, further illustrate various embodiments in accordance with the present invention. The figures together with the detailed description, hereinafter below, serve to explain various principles and advantages in accordance with the present invention.

FIG. 1 depicts, in a simplified and representative form, a first embodiment of a wireless local ad-hoc communications system suitable for utilization of an embodiment in accordance with the present invention;

FIG. 2 depicts, a block diagram of a communications device adapted to operate in the FIG. 1 system and in accordance with the present invention;

FIG. 3 depicts, a neighbor matrix depicting which devices in FIG. 1 are within communications range of each other as developed in accordance with the present invention;

FIG. 4 depicts a decision tree used for selecting a communications path in the FIG. 1 system according to the present invention; and

FIG. 5 depicts a flow chart of a method of selecting a communications path in the system of FIG. 1 in accordance with the present invention.

### DETAILED DESCRIPTION OF A PREFERRED EMBODIMENT

In overview form the present disclosure concerns wireless ad-hoc communications systems or networks and providing or selecting a communications path between communications devices operating therein or therewith. The systems of particular interest are those using ad-hoc techniques to establish small networks of communications devices in close proximity with each other. Such systems are known variously as personal area networks (PAN, an example being Bluetooth), or local or wireless local area networks (LAN or WLAN, examples include 802.11a or b, European HyperLan (version of 802.11) and Home RF). Such networks are characterized by a limited coverage area for service for any one device. As further discussed below various inventive principles and combinations thereof are advantageously employed to provide and select a communications path between a source device and a target device operating on such systems provided these principles or equivalents are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs without any undue experimentation. Therefore further discussion of such software, if any, will be limited in the interest of brevity and minimization of any risk of obscuring the principles and concepts in accordance with the present invention.

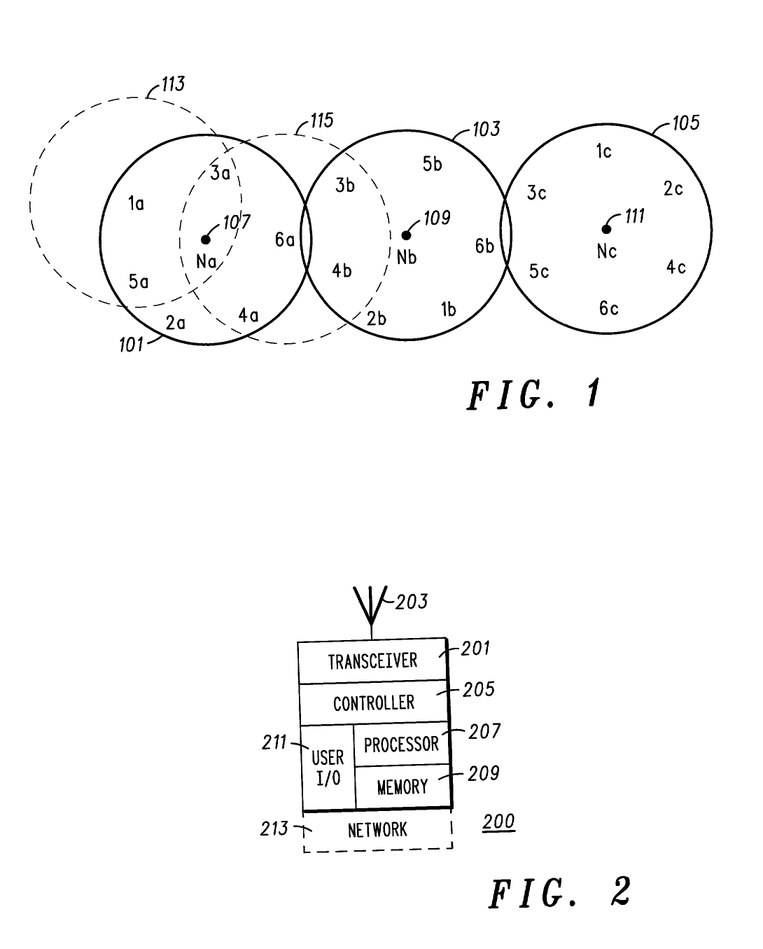

The present disclosure will discuss various embodiments in accordance with the invention. These embodiments include methods, communications devices, and communications systems employing each or all of the aforesaid. The system diagram of FIG. 1 will be used to lay the groundwork for a deeper understanding of the present invention and advantages thereof. FIG. 1 in large part and at the simplified level depicted is a representative diagram of a communications system 100, for example, a typical and known Bluetooth system, and will serve to explain the problems and certain inventive solutions thereto according to the present invention. While most if not all of the discussions below will be focused on a Bluetooth based system it is understood that the principles and concepts disclosed herein apply to the systems and like systems to those noted above FIG. 1 shows a first, second, and third piconet 101, 103, 105 generally providing wireless coverage in the circular areas depicted each with a master device or master (often a network access point) Na 107, Nb 109, and Nc 111 respectively. Each master is shown with 6 slaves 1a-6a, 1b-6b, and 1c-6c respectively. These slaves are devices or communications devices arranged and constructed to connect with or form a communications path with the respective master and vice-a-versa according to the Bluetooth standards. The Bluetooth standards as of the filing date of this application are available at www.bluetooth.com and are hereby incorporated by reference in their entirety into this disclosure.

With that overview some general discussion of the Bluetooth system will be provided in order to facilitate a better understanding of and appreciation for the inventive principles, concepts, and advantages of the present invention. The Bluetooth system operates in the 2.4 Giga-Hertz frequency range using frequency hopping techniques. In most countries 79 frequencies spaced one Mega-Hertz apart are provided. Each master device has an identification number that controls or establishes the particular frequency pattern or hoping channel used by the piconet including the master and any slaves connected via this piconet. Additionally the master controls channel access. Up to seven slaves can be active on any one piconet and up to 127 others can be locked to the master in a “parked state”. Each piconet can only have one master however slaves can participate in multiple piconets and a master in one piconet can be a slave in another. Of course when a given unit or device participates in multiple piconets it must do so on a timeshared basis. Multiple overlapping piconets are said to form a scatternet.

The Bluetooth channel is divided into time slots each 625 micro seconds in length with each time slot corresponding to a frequency hop giving a hopping rate, when active, of 1600 hops per second. Generally communications exchanges on the channel utilize a time division duplex arrangement wherein the master and slave alternate transmissions with the master transmitting on even numbered slots and the slave on odd numbered slots. Various types of links between the master and slaves are supported including synchronous connection oriented (SCO) links for voice service for example and asynchronous connection less (ACL) links for packet data service for example depending on the services required by the respective devices.

Very briefly a bluetooth unit uses either an inquiry procedure or paging procedure pursuant to channel access. The inquiry procedure allows a unit to discover which units are in range and what their device addresses, clocks, etc. are while the page procedure allows the formation of a connection. If an inquiry procedure is used and a neighboring unit is discovered, the inquiring unit will have to enter a page procedure to establish a connection with the neighboring unit. In any event, using these basic procedures and others, each of which is specified in the Bluetooth specifications, a scatternet, as noted above, can be formed. And with that and the principles disclosed herein, it becomes possible to find or establish a path for communications between two units or devices even when these units do not share a direct connection. While the above discussions have focused on Bluetooth based systems other ad-hoc wireless communications systems such as 802.11a or b, European Hyper Lan, Home RF, etc. have similar system concepts and capabilities. The balance of the discussions herein will focus more on the inventive principles and concepts and less, if any, on the mechanics and specifics of implementation in, for example, a Bluetooth based embodiment. In view of this disclosure and the specifications for such systems it is clear that one of ordinary skill will be able to practice the invention without undue experimentation.

Using the principles and concepts disclosed herein a path through an ad-hoc communications system such as a Bluetooth system can be determined or selected. Referring once more to FIG. 1, an area 113 is circumscribed by a dashed circle centered on device 1a. This area generally represents the likely coverage area of a potential piconet having 1a as the piconet master. By observation area 1a encompasses devices 3a, 5a, and Na. Similarly an area 115 centered on device 6a generally represents the coverage area for device 6a and that includes 3a, 4a, Na, 3b, and 4b. Each device 1a and 6a, using the inquiry procedures above can determine its neighbor list or list of neighbor devices that are capable of communicating with it or at least the ones that are both capable and willing. Note a response to an inquiry includes the responding devices address.

By extending this notion, any device using the inquiry procedures can discover its neighbor devices. The diagram or matrix or neighbor matrix shown in FIG. 3 results when all of this information is collected for the system of FIG. 1. In FIG. 3 the horizontal and vertical axis are each labeled with a reference corresponding to each of the devices in FIG. 1. The intersections marked by a dot are intended to represent that a connection between the devices on the respective axis is possible. For example, reading vertically or horizontally from the 6a reference on either axis we see that connections with devices 3a, 4a, Na, 3b, and 4b are possible, which agrees with the observations regarding area 115 discussed above.

Further by measuring received signal strength as devices respond to the inquiry a device can get an assessment of likely quality of a link between the devices. The substance of the response or a further exchange can be used to: determine or assess other merits of the link; such as other attributes of link quality, such as bit error rate; what capabilities the neighbor device may support and whether these align with a users preferences; a traffic load at the neighbor device; or availability of the neighbor device for a contemplated communications task dependent on length of the task, remaining battery life, services desired for the task. Although FIG. 3 shows dots at the intersections it is contemplated that a database with all or part of the information in FIG. 3 would include an assessment of the above noted merits and attributes of quality and suitability in lieu of the dots.

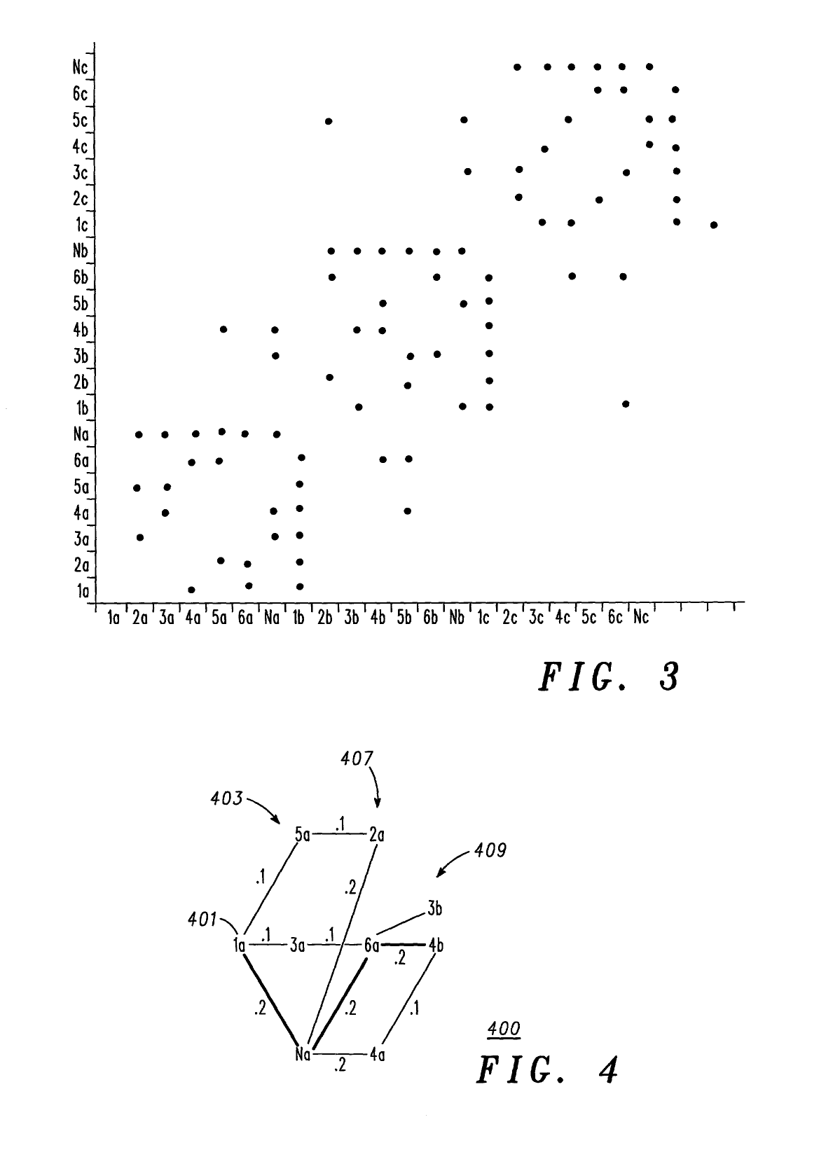

FIG. 2 depicts, a block diagram of a communications device embodiment adapted to operate in the FIG. 1 system. The communications device 200 is arranged and constructed to operate in the ad-hoc wireless communications system and in so doing to select a path for communications with a target device. This device is a typical block diagram that is representative of any of the devices of FIG. 1, such 1a, 2b, 3c, or the network access units Na 107, Nb 109, Nc 111 or devices or masters for the piconets depicted. The communications device includes a transceiver 201 coupled to an antenna 203 and a controller 205. Generally the controller 205, comprised of the processor 207 coupled to a memory 209, will be further coupled to a user interface or I/O 211 including one or more of such items as keyboard, display, and audio microphone and speaker. Often when the communications device is a network access unit it will also include coupled to the controller a network transceiver 213 that provides an interface to, for example a local area network with servers, gateways, etc. or perhaps to the public switched telephone network.

The transceiver 201 will include a receiver including capability to measure signal strength, a transmitter, and a frequency generation unit such as a phase locked loop. The transceiver will operate under the control of the controller 205 to convert base band signals to and from radio signals that are transmitted and received in accordance with the specific system and as generally known to one of ordinary skill. The user via the I/O 211 may cause the communications device to transmit and receive various signals or alternatively provide a way for a user to consume or observe/comprehend information obtained from such signals. The processor 207 may be a microprocessor and digital signal processor or some combination suitable to provide the control and signal processing abilities required. The memory 209 is one or more forms of known storage such as RAM, ROM, PROM, or magnetic media. The memory is used to store the software instructions for the processor or user I/O and data bases required to operate in the specific system, such as Bluetooth. Additionally, for example, in one embodiment the memory may be used for storing a database including the information or relevant portion of the information discussed with reference to FIG. 3 and further below with reference to the FIG. 4 decision tree 400 used for selecting a communications path in the FIG. 1 system.

In more, as well as more germane, detail, pursuant to the communications device, as a source device or unit, selecting a path for communications with a target or destination device, the transceiver 201 and controller 205 will collectively operate to first determine a first layer or set of neighbor devices, where each such neighbor device within this first layer is capable of and willing to communicate with the device or transceiver. To further clarify this notion an example will be explained from which the reader will be able to generalize and appreciate the concepts and principles and advantages thereof disclosed herein. This example will be explained from the perspective of an ad-hoc wireless communications system such as a Bluetooth based system but would be analogous if an IEEE 802.11b system were used.

Suppose that device 1a of FIG. 1 wishes to interact or communicate with device 4b and is thus faced with determining or selecting a path therefore. Initially device 1a as the source node or device 401 or layer 0 using the inquiry or paging procedures for example will determine this first layer 403, specifically, comprised of the devices it can communicate with. By observation of area 113 or reference to the matrix of FIG. 3 this will include device 3a, 5a, and Na shown as layer 1 403 in FIG. 4.

Next each of the layer one devices will determine, for example as a result of a request from the source device 1a, its respective neighbor devices or devices in addition to the source device that it is able to communicate with. In general the transceiver and controller cause to be determined or successively determine additional layers of neighbor devices, each neighbor device within a particular layer capable of communicating with one or more neighbor devices within a preceding layer, until the target device is identified as one of these neighbor devices. In our example the second layer 407 is formed, by noting that device 5a, from FIG. 3, can communicate with the source device 1a, and 2a, and the master Na. Ignoring or discarding all devices that have been shown or accounted for in a previous layer only device 2a is depicted. Device 3a can communicate with 1a, 6a, and Na. The only new device (not shown in earlier layers) to be shown in FIG. 4 at the second layer 407 is 6a. Na can communicate with devices 1a-6a but applying the new device rule only path portions or links from Na to 2a, 6a, and 4a are depicted.

Continuing, for example as a result of a request by the preceding layer devices using the inquiry and paging procedures, to identify successive layers until the target device is identified results in layer 3 409. Device 2a can communicate with 4a, 5a, and Na but each of these have previously been identified so no as yet unidentified neighbor devices for 2a are noted in layer 3. Device 6a can communicate with 3b and 4b in addition to previously identified 3a, 4a, and Na thus 3b and 4b are identified at layer 3 409. Similarly device 4a is able to reach 4b. Note the target device 4b has now been identified as a neighbor device at layer 3, otherwise considered the destination layer. It is contemplated that the information above gathered used to construct the matrix of FIG. 3 and decision tree of FIG. 4 will be returned or forwarded to a common point or device such as the source device 1a or target device 4b or perhaps a device acting as a temporary controller such as Na or perhaps a LAN server.

In the preferred embodiment where the information is returned to the source device the controller of that device will now select the path including intervening neighbor devices capable of communicating with each other to form the path for communications from the transceiver of the source device to the target device. In our example the source device 1a can now select the path from 1a to 3a to 6a to 4b or from 1a to Na to either 6a or 4a and on to 4b. To determine which of these three paths is more appropriate a weight, corresponding to the relative merits of using the link as a portion of the path under the present circumstances, can be assigned to each portion or link within a potential path and a cumulative or composite weight for a path then used to make the decision.

Various factors will enter into assigning these weights for each link or portion of a potential path. For example along with determining the devices within each layer by discovering a device's neighbor devices it must also be determined or confirmed that each of the neighbor devices is appropriate and available to participate in the path. For example is the link quality for a link ending at one of the neighbor device and originating at another one in a preceding layer above some threshold value where this threshold may be task specific. Besides link quality does the neighbor device have appropriate capabilities? For example, if the source device needs a connection oriented link for its purposes selecting a device that only supports connection less links is not appropriate. Does the traffic load or likely traffic load, at the neighbor device, allow for additional duties? For example, if an SCO link is already supported and we need another such link this may not be desirable. Is there some other factor such as remaining battery life that may impact availability of the neighbor device? This will depend on likely load or likely duration contemplated for the path. What link or path is likely to produce or result in less additional system overhead? For example it may be advantageous to use existing links representing existing connections rather than forming new ones. It is likely that an assigned weight must satisfy some threshold in order for that link to be selected as a portion of the path. In this case the tree structure of FIG. 4 could be further simplified by leaving out links that are not appropriate for whatever reason. Incidentally, there is no guarantee that a suitable path will be found.

Note that FIG. 4 can be further simplified by making Viterbi like decisions at each node or device where multiple links are terminated. This decision would be based on a composite weight for each link where that composite weight was a summation of the weights for all links forming the sub path ending at the node. Only the sub path with the better or larger composite weight would survive with any other possibilities being eliminated. In general when a first link and a second link terminate at one of the neighbor devices, the first link is chosen as a surviving link when a composite weight for the first link is better than a second composite weight for the second link. In our example for examples sake, weights for each of the links have been assigned. Links going through the master device Na have been assigned a 0.2 weighting as these would seem to be least disruptive to the balance of the system and other links around Na (1a to 3a and to 6a) have been assigned a 0.1 weighting. Additionally a weight of 0.2 has been assigned to the 6a to 4b link and 0.1 to the 4a to 4b link, perhaps due to link quality. In any event by comparing the composite weights for the two sub paths terminating at device 6a, respectively 0.4 versus 0.2, the one through 3a can be discarded. At device 4b the composite weights of 0.6 versus 0.5 results in selecting or choosing the path from the source device 1a to the target device 4b as the collection of surviving links ending at the target unit, specifically 1a to Na to 6a to 4b. Note that the source device or communications device that originates the path requirement or alternatively one of the other devices must operate to collect information corresponding to each link and the weight for the link to facilitate the path selection.

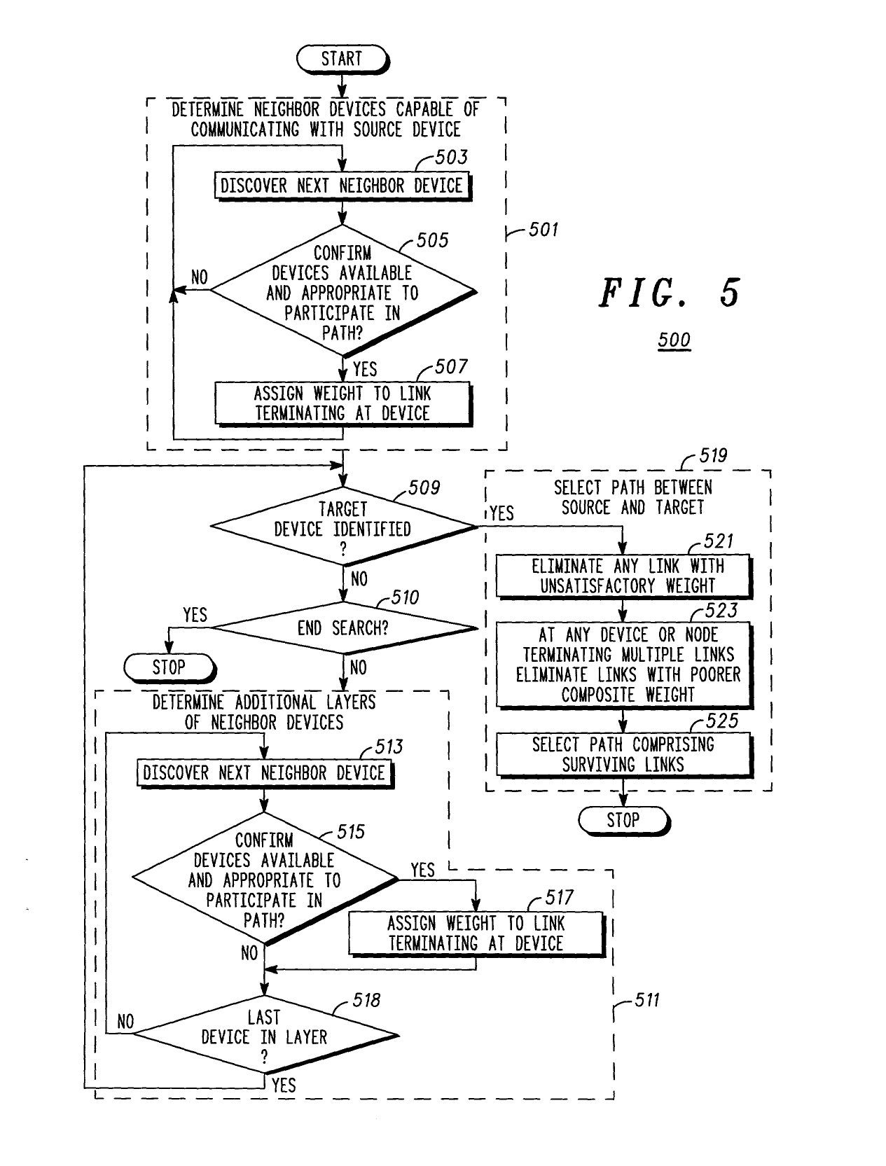

In a method embodiment the present invention may be explained with reference to the FIG. 5 flow chart. Note this discussion may be somewhat duplicative of the above explanation so will be undertaken at a more general level and in the nature of a review. Generally the method 500 is set in an ad-hoc wireless communications system such as a Bluetooth or the like system, and is a procedure or method of selecting a path for communications between a source device and a target device, for example 1a and 4b. The method starts and at step 501 determining a layer of neighbor devices, each neighbor device within this layer capable of communicating with the source device is undertaken. This step includes steps 503, 505, 507. Step 503 is devoted to discovering each neighbor device, while step 505 confirms that the neighbor device is appropriate and available to participate in the path. Step 507 assigns a weight, corresponding to the relative merits of using the link as a portion of the path, for a link ending at the neighbor device and originating at source device. These steps are repeated until all devices capable and suitable for communicating with the source device have been accounted for.

Then step 509 tests whether the target device has been identified as a neighbor device and if not step 510 determines whether the search should end. As noted earlier there is no assurance that a path will be found and no assurance that one that is found will be satisfactory. Criteria for ending the search can be a limit on search time or a limit on number of links that would comprise a path. For example if a path will exceed 5 links perhaps it will be too lengthy or if each link includes an economic burden perhaps too costly. It is anticipated that practicalities will determine the criteria for discontinuing the search. In any event given that the search should continue step 511 determines an additional layer of neighbor devices, each neighbor device within this particular layer capable of communicating with one or more neighbor devices within a preceding layer. Steps 513, 515, 517 essentially duplicate steps 503 -507. When the last device in a layer has been determined at step 518, the process loops back to step 509 and will be repeated thus successively determining additional layers until the target device is identified as one of these neighbor devices. In which case, from step 509 the process proceeds to step 519 which shows selecting the path including intervening neighbor devices capable of communicating with each other to form the path for communications from the source device to the target device. Step 521 shows eliminating any link with a weight that does not satisfy a threshold and is thus unsatisfactory. Step 523 shows that any time two links terminate at one device or node the link or sub path with the poorer or lesser composite weight is eliminated, thus the sub path with the better composite weight survives. The path is chosen as a collection of surviving links, step 525, ending at the target unit where the weighting and comparing procedures between link weights or composite weights is used to eliminate sub paths until one path remains. The process ends after step 525 or after step 510 determines that the search should end.

In practice where this device to device communications is supported it may prove to be advantageous for each device to pre-determine and periodically update its own list of neighbor devices including capability and availability for supporting various device to device ad-hoc communications paths. In that case when a device requests such information it would be more or less immediately available and could be returned very quickly. Alternatively each device may determine or discover the information shown in FIG. 3 and, possibly, the weights in FIG. 4 and periodically update it. The information would be provided to one or more common storage locations, such as a common server on a LAN or perhaps the master of its or each piconet in the ad-hoc system. A source device could then access the common storage area(s) for all or part of the information required to establish a path. With this approach the latency in establishing or selecting a path due to data collection would be reduced.

The actual path selection as described above can be done at or through the source device or source communications unit or it can be performed at the target or destination unit. In either case the relevant information including each potential link or portion of the path will have to be forwarded to the respective unit making the decision. Alternatively the decision regarding the path could be performed with a controller at the common storage location(s) provided again all relevant information was available to that controller. This would include the various criteria involved in weighting the links and sub paths or sufficient information regarding the contemplated exchange between the source and target units so as to allow a proper weight to be assigned.

A further approach to the responsibility for selecting the path would be a distributed decision process wherein each neighbor device in the path or potential sub paths would make certain decisions. For example if a link originating at one device and terminating at another is unsatisfactory the originating device can make that decision provided the basis for making the determination is available. For example if the source device requires a certain link quality such as signal to noise or received signal strength the device could eliminate links on that basis. Alternatively if two or more links terminate at a device and the device knows or can determine their composite weights the best sub-path can be selected and the other eliminated. With this approach the target device would likely be the final decision point and the selected path would need to be returned to the source unit. Note; no one device including the source device needs to be aware of the complete path. Rather each device only needs to be aware of one other device in the case of the source and target devices or two other devices in the case of an intervening device.

An additional approach or way of looking at the above explained approach to selecting a path from a source device to a target device is the source device broadcasts a token, for example as part of the inquiry process, that includes an identifier or address for the source device and the target device together with any specifics required for weighting a link or path to any neighbor device that can receive the broadcast message. Each neighbor device that receives the broadcast adds a weight for the link over which the broadcast was received, selects the best of multiple links and then re-broadcasts the token including the resultant weight and its own address. In this fashion the token spreads until it reaches the target device. The target device makes any final path selection and returns a response message back down the path, requesting that each member of the path become active and participate in the subsequent communications or exchange with the source device.

Various embodiments concerning device to device communications in a wireless ad-hoc communications system, such as Bluetooth, 802.11a or b, European HyperLan, or Home RF and more particularly selecting a path for such communications to advantageously provide such services for communications devices have been discussed and described. The disclosure extends to the constituent elements or equipment comprising such systems and the methods employed thereby and therein. Using the inventive principles and concepts disclosed herein advantageously allows or provides for device to device communications within the systems without using or accessing any services external to the ad-hoc system. This disclosure is intended to explain how to fashion and use various embodiments in accordance with the invention rather than to limit the true and intended scope and spirit thereof. The invention is intended to be defined solely by the appended claims, as may be amended during the pendency of this application for patent, and all equivalents thereof.

What is claimed is:

1. In an ad-hoc wireless communications system a method of selecting a path for communications between a source device and a target device, the method including the steps of:
determining a first layer of neighbor devices, each neighbor device within said first layer capable of communicating with the source device;
successively determining additional layers of neighbor devices, each neighbor device within a particular layer capable of communicating with one or more neighbor device within a preceding layer, until the target device is identified as one of said neighbor devices; and
selecting the path including intervening neighbor devices capable of communicating with each other to form the path for communications from the source device to the target device.

2. The method of claim 1 wherein the ad-hoc wireless communications system within which the method is practiced is a Bluetooth based system.

3. The method of claim 1 wherein the ad-hoc wireless communications system within which the method is practiced is on e of an IEEE 802.11a, 802.1b and European HyperLan based system.

4. The method of claim 1 wherein said step of determining further includes discovering said each neighbor device and confirming that said each neighbor device is appropriate and available to participate in the path.

5. The method of claim 1 wherein said step of successively determining said additional layers of neighbor devices further includes assigning a weight for a link ending at a one of said each neighbor device and originating at a one of said one or more neighbor device.

6. The method of claim 5 wherein said weight corresponds to the relative merits of using said link as a portion of the path.

7. The method of claim 6 wherein said weight corresponds to one of; link quality, said one of said each neighbor device capabilities, a traffic load at said one of said each neighbor device; and availability of said one of said each neighbor device.

8. The method of claim 7 wherein said weight must satisfy a threshold in order for said link to be selected as said portion of the path.

9. The method of claim 8 wherein, when said link and a second link terminate at said one of said each neighbor device, said link is chosen as a surviving link to said one of said each neighbor device when a composite weight for said link is better than a second composite weight for said second link.

10. The method of claim 9 wherein the path is chosen as a collection of said surviving links ending at the target unit.

11. The method of claim 6 further including a step of collecting information corresponding to each link and said weight for said link at one of the device and said neighbor devices.

12. A communications device operating in an ad-hoc wireless communications system to select a path for communications with a target device, comprising in combination:
a transceiver coupled to a controller and collectively operating to;
determine a first layer of neighbor devices, each neighbor device within said first layer capable of communicating with the transceiver;
successively determine additional layers of neighbor devices, each neighbor device within a particular layer capable of communicating with one or more neighbor device within a preceding layer, until the target device is identified as one of said neighbor devices; and
selecting the path including intervening neighbor devices capable of communicating with each other to form the path for communications from the transceiver to the target device.

13. The communications device of claim 12 wherein the ad-hoc wireless communications system is a Bluetooth based system.

14. The communications device of claim 12 wherein the ad-hoc wireless communications system is one of an IEEE 802.11a, 802.11b, and European HyperLan based system.

15. The communications device of claim 12 wherein said first layer of neighboring devices is determined by discovering said each neighbor device and confirming that said each neighbor device is appropriate and available to participate is the path.

16. The communications device of claim 12 wherein additional layers of neighbor devices are successively determined and further a weight is assigned for a link ending at a one of said each neighbor device and originating at a one of said one or more neighbor device.

17. The communications device of claim 15 wherein said weight corresponds to the relative merits of using said link as a portion of the path.

18. The communications device of claim 17 wherein said weight corresponds to one of; link quality, said one of said each neighbor device capabilities, a traffic load at said one of said each neighbor device; and availability of said one of said each neighbor device.

19. The communications device of claim 18 wherein said weight must satisfy a threshold in order for said link to be selected as said portion of the path.

20. The communications device of claim 19 wherein, when said link and a second link terminate at said one of said each neighbor device, said link is chosen as a surviving link to said one of said each neighbor device when a composite weight for said link is better than a second composite weight for said second link.

21. The communications device of claim 20 wherein the path is chosen as a collection of said surviving links ending at the target unit.

22. The communications device of claim 17 wherein one of said neighbor devices and the communications unit operate to collect information corresponding to each link and said weight for said link to facilitate the path selection.
